(19) United States
(12) Patent Application Publication
(10) Pub. No.: US 2003/0000826 A1
(43) Pub. Date: Jan. 2, 2003

(54) Method for the production of gas- and liquid-impermeable layers on a substrate

(76) Inventors: Jorg Krempel-Hesse, Ortenberg-Eckartsborn (DE); Michael Liehr, Feldatal (DE); Volker Hacker, Altenstadt-Oberau (DE); Elisabeth Budke, Alzenau (DE); Helmut Grimm, Darmstadt (DE)

Correspondence Address: FULBRIGHT & JAWORSKI, LLP, 666 FIFTH AVE, NEW YORK, NY, 10103-3198, US

(21) Appl. No.: 10/179,914

(22) Filed: Jun. 25, 2002

(30) Foreign Application Priority Data
Jun. 28, 2001 (DE) 101 30 666.0

(51) Int. Cl. C01B 31/00

(52) U.S. Cl. 204/173

(57) ABSTRACT

The invention relates to a method for the production on a substrate of gas- and liquid-impermeable layers, which have a relatively high elasticity. This elasticity is attained through the inclusion of carbon in a layer comprised of a metal or semiconductor oxide. In order to attain such an inclusion, a metal or semiconductor is ionized by means of an arc discharge. Subsequently, a reactive gas, for example O₂, is introduced, with which the ionized metal or the ionized semiconductor forms an oxide. In addition, a carbon-containing gas is added, which releases its carbon such that on the substrate an oxide layer is formed, in which carbon is included.

### FIELD OF THE INVENTION

The invention relates to a method for the production of gas- and liquid-impermeable layers on a substrate.

### BACKGROUND OF THE INVENTION

As a rule, synthetic materials conventionally employed for packaging or as containers are not sufficiently diffusion-tight for volatile substances, such as carbon-based compounds or flavorings and fragrances, as well as for gases, such as hydrocarbons, oxygen, carbon dioxide and water vapor. This is especially disadvantageous in the case of thin-walled packaging, such as for example films/foils or packaging under gas pressure, which contain, for example, CO₂-containing refreshment beverages.

It is therefore known to provide packaging of synthetic material with diffusion barrier layers. Optically transparent barrier layers are produced in known manner by vapor deposition of metal oxides, most often Al₂O₃ or substoichiometric silicon oxide, SiOₓ, onto the substrate surface.

Alternatively, quartz-like SiO₂ layers are also produced by a plasma-enhanced chemical gas phase deposition process (PECVD) from an organosilicon compound with an excess of oxygen, such as is found in the publication J. T. Felts: “Transparent Gas Barrier Technologies”, Society of Vacuum Coaters 33rd Ann. Tech. Conf. Proc. (1990), pp. 184 to 193, and EP 0 299 754 B1. Compared to vapor-deposited SiOₓ layers, the SiO₂ layers produced by means of PECVD processes have a higher optical transparency and a markedly improved barrier effect as well as greater tensile strength.

The pure SiO₂ or SiOₓ layers, however, present the disadvantage that they are rather brittle and tear easily.

It has therefore already been proposed to incorporate carbon into these layers by means of various methods (DE 44 04 690 A1, DE 44 38 359 A1, DE 198 02 506 A1, DE 198 02 333 A1), in order thereby to make the layers more elastic. Most processes, however, do not allow the rapid coating of large quantities, which is required, for example, when coating transparent synthetic material beverage bottles. This applies, for example, to the frequently employed PECVD process (WO 99/19229) and to the CVD process (U.S. Pat. No. 5,641, 559).

The listed processes, moreover, entail disadvantage that, due to the relatively high process gas pressures conventionally applied of 0.1 to 1 mbar, during the coating process high-level impurities are generated in the coating installation and in the vacuum installations. These impurities cause high purification and maintenance expenditures. It is furthermore disadvantageous that due to the process, complexly structured and highly cost-intensive educts must be employed, which after a “crack process” in a plasma must first be decomposed into the building blocks required for the layer generation.

In addition, a process for material coating is known in which the material to be coated is exposed in an underpressure chamber to material vapor, which is generated by means of an arc discharge (EP 0 158 972 B1). Herein the material to be vaporized is connected to the anode of a voltage source.

The invention addresses the problem of producing carbon-containing coatings on substrates with the aid of an arc discharge.

This problem is solved according to the method of the present invention.

### SUMMARY OF THE INVENTION

The invention relates specifically to a method for the production of a layer and a layer system producible therewith in a plasma-enhanced gas-phase deposition process, wherein this layer contains an increased carbon fraction and exclusively, or in addition to, the known transparent barrier layers for synthetic films/foils and synthetic containers. The additional carbon originates from a carbon-containing medium, which is in the gaseous state during the plasma discharge in a vacuum and releases the carbon through, for example, ionization. The process can be carried out at relatively low pressures; very few impurities are generated thereby which would disturb the operation of the installation. Moreover, as the carbon carriers highly cost-effective short-chain silicon oils or short-chain hydrocarbon compounds can be employed, which permits the synthesis of the layer from simple and inexpensive starting materials. The additionally incorporated carbon effects primarily an improvement of the elasticity of the layer.

The advantage attained with the invention comprises in particular that rapid coating becomes possible and the impurities are markedly decreased. In addition, the method according to the invention inhibits the permeation of gaseous and/or liquid substances, in particular of hydrocarbons, oxygen, water vapor and of CO₂, through the coated substrate.

Furthermore, according to the invention, in addition to the starting materials conventionally employed in the case of anodic arc vaporization, including the cathode materials, for the required carbon-containing and in gaseous form under pressure carrier medium of the carbon to be incorporated in the barrier layer a cost-effective educt, preferably short-chain silicon oils, for example HMDSO (hexamethyl disiloxane), TMDS (tetramethyl disiloxane) and their derivatives, or short-chain hydrocarbon compounds with single, double and triple bonds, for example methane, ethane, ethene or acetylene are employed. Through the use of these simple and not cost-intensive starting products, the production and the structure of the carbon-containing layer in the form of a synthesis, i.e. specific supply of the required components for the barrier layer to be generated as molecules and atoms from the primary components oxygen, silicon and carbon, can take place much more economically than has previously been possible.

The invention also improves significantly the effect of such barrier layers on hollow bodies of synthetic material, which are subjected to increased thermal loading cycles, for example higher temperatures and higher relative humidity, as well as also their resistance to abrasive wear-and-tear which has a favorable effect on durability, for example, in automatic bottling installations.

The method according to the invention will be explained in conjunction with the drawings described in the following.

### BRIEF DESCRIPTION OF THE FIGURES

FIG. 1 depicts a coating installation.

FIG. 2 depicts a substrate with a high carbon-content barrier layer.

FIG. 3 depicts a substrate with a high carbon-content and a conventional barrier layer.

FIG. 4 depicts a substrate with three layers.

### DETAILED DESCRIPTION

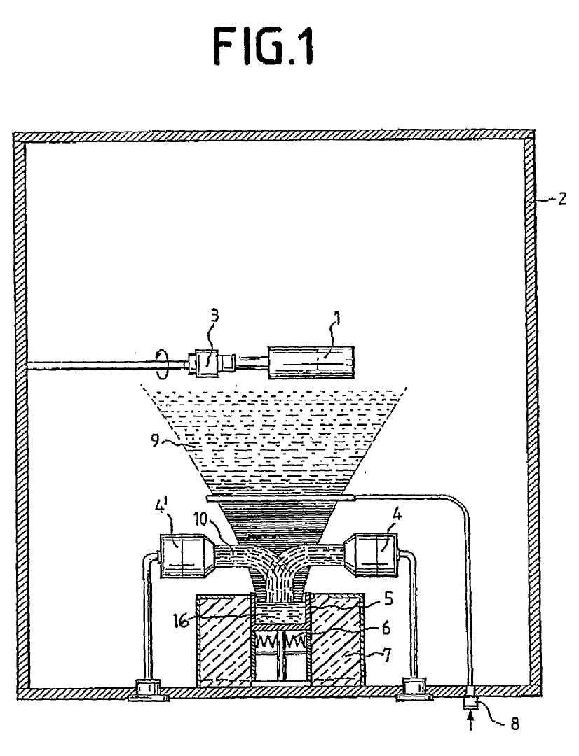

In FIG. 1 the principle of a coating installation is shown, with which the method according to the invention is carried out. This coating installation comprises a vacuum treatment chamber 2, in which is disposed a rotatable receiving device 3 for a hollow body 1 to be coated.

This hollow body can be a bottle comprised of a transparent synthetic material.

Underneath this hollow body 1 is disposed a gas inlet tube 8, via which a carbon-containing gas and, if appropriate, a reactive gas is introduced into the vacuum treatment chamber 2. Underneath the horizontally extending portion of the gas inlet tube are disposed two electrodes 4′, 4, which preferably are at the negative potential of a (not shown) voltage source. Underneath these electrodes 4′, 4, which can be magnesium electrodes, is disposed a vaporization crucible 5, which can be heated in a heater 6 and in which is disposed a coating material 16 to be vaporized. About the vaporization crucible 5 and the heater 6 is provided a thermal insulation 7. The coating distance is approximately 25 to 50 cm.

If a DC voltage of, for example, 24 V is applied between electrodes 4, 4′ and vaporization crucible 5, with appropriate material in crucible 5 and with appropriate distance between the electrodes 4, 4′ and the coating material 16 in crucible 5 an arc discharge 10 forms. In order to attain reliable ignition of the arc discharge, at the beginning an ignition aid known per se, for example in the form of a [spark gap] ignition pin can also be employed, which is at positive potential, or by generating a plasma above the material to be vaporized with means known per se.

Through the arc discharge 10 the coating material 16 in the vaporization crucible 5 is vaporized and ionized. Consequently, above the vaporization crucible an ionized vaporization lobe 9 develops. If the vaporized material is, for example, silicon and if, via the gas inlet tube 8, a mixture of O₂ and HMDSO is introduced, the silicon combines with the oxygen and the HMDSO dissociates and releases carbon. Onto the rotating hollow body 1 subsequently a mixture of carbon and SiO₂ or SiOₓ is transported and forms here a layer which is transparent and has strong adhesion properties. The adhesion is brought about by physical and/or chemical bonding forces between the SiO₂ or SiOₓ and the carbon. The inclusion of the carbon can lead to various matrices, depending on the type and quantity of material.

In the case of relatively large quantities of material in the vaporization crucible, it can occur that the arc discharge 10 alone does not suffice to bring about vaporization. In this case the heater 6 is connected as additional heating means.

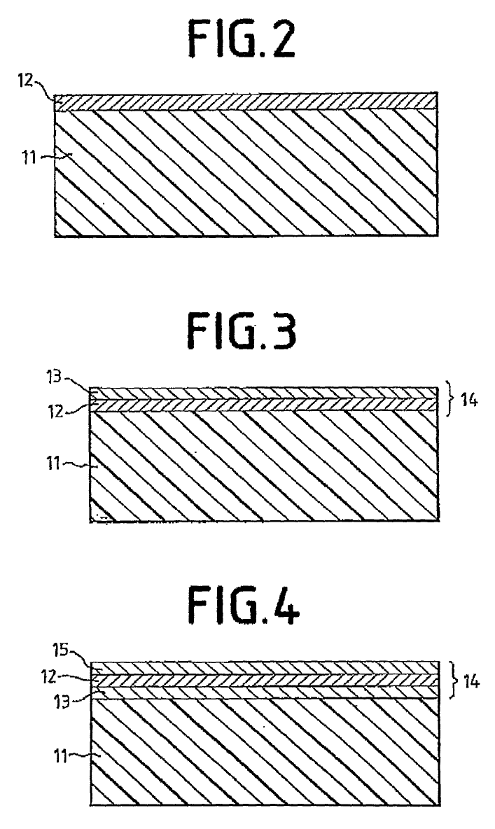

FIG. 2 depicts a substrate 11, on which a high carbon-content layer 12 was applied with the above described method.

FIG. 3 is depicted a substrate 11 with two layers, with the first layer 12 again being a high carbon-content layer and the second layer 13 a standard layer comprised of, for example, SiO₂ or SiOₓ. The second layer can also be applied with the installation depicted in FIG. 1.

FIG. 4 shows a substrate 11 on which three layers 13, 12, 15 are applied, wherein the first layer 13 is a conventional standard barrier layer, for example of SiO₂, the second layer 12 is a high carbon-content layer and the third layer 15 is a protective layer.

A base layer can additionally be introduced between the substrate 11 and the first layer 12 or 13.

The alternating coating with standard layer and high carbon-content layer can be repeated any number of times and each layer type can represent the beginning as the first layer on the substrate.

It is furthermore possible to apply optionally additionally a first base layer and/or as a terminal layer an upper cover layer with a different layer matrix in each instance. By matrix is herein understood a material which comprises another substance as an inclusion, for example SiO which includes C. The type of this inclusion can be different, and specifically as a function of the employed materials, their concentration and the distances between the vaporization crucible, the gas inlet tube and the substrate.

Although the method is preferably carried out with the aid of a DC arc discharge, it is also possible to utilize an AC arc discharge.

What is claimed is:

1. Method for the production of gas- and liquid-impermeable layers on a substrate, characterized by the following steps:
a) an arc discharge is generated between an electrode (4, 4′) and a coating material (16);
b) into the space between the coating material (16) and the substrate (1) carbon or a carbon-containing compound is introduced.

2. Method as claimed in claim 1, characterized in that, in addition to the carbon or the carbon-containing compound, a reactive gas is introduced.

3. Method as claimed in claims 1 and 2, characterized in that the reactive gas and the carbon or the carbon-containing compound are introduced jointly and at the same site.

4. Method as claimed in claims 1 and 2, characterized in that the reactive gas is introduced at a different site than the carbon or the carbon-containing compound.

5. Method as claimed in claim 1, characterized in that the coating material is a metal, a metal compound, a semiconductor or a semiconductor compound.

6. Method as claimed in claim 5,characterized that the metal is aluminum.

7. Method as claimed in claim 5, characterized in that the semiconductor is silicon.

8. Method as claimed in claim 1, characterized in that the carbon-containing compound is a gas.

9. Method as claimed in claim 1 or claim 8, characterized in that the carbon-containing compound contains a short-chain silicon oil, for example HMDSO (hexamethyl disiloxane) and/or TMDS (tetramethyl disiloxane) and/or their derivatives and/or short-chain hydrocarbon compounds with single, double and/or triple bonds, for example, methane, ethane, ethene and acetylene.

10. Method as claimed in claim 1, characterized in that the coating material (16) is heated by means of a heater (6).

11. Method as claimed in claim 1, characterized in that the coating material (16) is vaporized by means of a heater (6).

12. Method as claimed in claim 1, characterized in that it is carried out at a process pressure in the range from 1×10⁻⁴ to 5×10⁻³ mbar.

13. Method as claimed in claim 1, characterized in that that the arc discharge is generated by means of a DC voltage, wherein the electrode is at negative potential and the coating material at positive potential.

14. Method as claimed in claim 1, characterized in that the arc discharge is generated by means of an AC voltage.

15. Method as claimed in claim 1, characterized in that the substrate is comprised of synthetic material.

16. Method as claimed in claim 1, characterized in that a first arc discharge takes place between a first electrode (4) and the coating material (16) and a second arc discharge between a second electrode (4′) and the coating material (16).

17. Method as claimed in claim 1 and claim 2, characterized in that the coating material (16) is vaporized and ionized by the arc discharge, that further the ionized coating material forms compounds with the reactive gas, and that these compounds, together with carbon or carbon compounds, form a layer on the substrate.

18. Method as claimed in claim 17, characterized in that the reactive gas is O₂.

19. Method as claimed in claim 17, characterized in that the layer has a carbon fraction of 2.5% to 15%.

20. Method as claimed in claim 1, characterized in that onto the substrate (1) only a carbon-containing layer (12) is applied.

21. Method as claimed in claim 1, characterized in that onto the substrate (1) first a carbon-containing layer (12) and thereupon a low carbon-content standard barrier layer (13) is applied.

22. Method as claimed in claim 1, characterized in that onto the substrate first a low carbon-content standard barrier layer (13) is applied, hereupon a carbon-containing layer (12) and subsequently an outer protective layer.

23. Method as claimed in claim 21 or claim 22, characterized in that the low carbon-content standard barrier layer is an oxide of Si, Al, Mg or Cr.

24. Method as claimed in claim 21, characterized in that the layers are transparent to light.

25. Method as claimed in claim 1, characterized in that the layers are transparent to microwaves.

26. Method for the production of gas- and liquid-impermeable layers on a substrate, comprising the following steps:
a) generating an arc discharge between an electrode and a coating material; and
b) introducing carbon or a carbon-containing compound into the space between the coating material and the substrate.

27. A method as claimed in claim 26, further comprising the step of introducing a reactive gas into the space between the coating material and the substrate.

28. A method as claimed in claim 27, wherein the reactive gas and the carbon or the carbon-containing compound are introduced jointly and at the same site.

29.. A method as claimed in claim 27, wherein the reactive gas is introduced at a site different from that of the introduction of the carbon or the carbon-containing compound.

30. A method as claimed in claim 26, wherein the coating material is selected from the group consisting of a metal, a metal compound, a semiconductor and a semiconductor compound.

31. A method as claimed in claim 30, wherein said metal is aluminum.

32. A method as claimed in claim 30, wherein said semiconductor is silicon.

33. A method as claimed in claim 26, wherein said carbon-containing compound is a gas.

34. A method as claimed in claim 26, wherein the carbon-containing compound comprises a short-chain silicon oil, for example HMDSO (hexamethyl disiloxane) and/or TMDS (tetramethyl disiloxane) and/or their derivatives and/or short-chain hydrocarbon compounds with single, double and/or triple bonds, for example, methane, ethane, ethene and acetylene.

35. A method as claimed in claim 26, wherein the coating material is heated by means of a heater.

36. A method as claimed in claim 26, wherein the coating material is vaporized by means of a heater.

37. Method as claimed in claim 26, wherein the process is method is carried out at a pressure in the range of from 1×10⁻⁴ to 5×10⁻³ mbar.

38. A method as claimed in claim 26, wherein the arc discharge is generated by means of a DC voltage, and wherein the electrode is at negative potential and the coating material at positive potential.

39. A method as claimed in claim 26, wherein the arc discharge is generated by an AC voltage.

40. A method as claimed in claim 26 wherein the substrate comprises synthetic material.

41. A method as claimed in claim 26, wherein a first arc discharge occurs between a first electrode and the coating material and a second arc discharge occurs between a second electrode and the coating material.

42. A method as claimed in claim 26, wherein the coating material is vaporized and ionized by the arc discharge, the ionized coating material forms compounds with the reactive gas, and that said compounds, together with said carbon or carbon compounds, form a layer on the substrate.

43. A method as claimed in claim 42, wherein the reactive gas is O₂.

44. A method as claimed in claim 43, wherein the layer has a carbon fraction of 2.5% to 15%.

45. A method as claimed in claim 26, wherein only a carbon-containing layer is applied onto the substrate.

46. A method as claimed in claim 26, wherein first a carbon-containing layer is applied to the substrate and a low carbon-content standard barrier layer is applied on said carbon-containing layer.

47. A method as claimed in claim 26, wherein first a low carbon-content standard barrier layer is applied to the substrate, a carbon-containing layer is applied to the standard barrier layer; and an outer protective layer is applied to the carbon-containing layer.

48. A method as claimed in claim 46, wherein the low carbon-content standard barrier layer comprises an oxide of at least one of Si, Al, Mg and Cr.

49. A method as claimed in claim 46, wherein said layers are transparent to light.

50. A method as claimed in claim 26, wherein said layers are transparent to microwaves.
